(19) United States
(12) Patent Application Publication
(10) Pub. No.: US 2003/0172295 A1
(43) Pub. Date: Sep. 11, 2003

(54) Device and system for allowing secure identification of an individual when accessing information and a method of use

(75) Inventors: Larry Lawson Jones, Palo Alto, CA (US); Sreenath Mambakkam, San Jose, CA (US); Arockiyaswamy Venkidu, Menlo Park, CA (US); Nicholas Antonopoulos, San Jose, CA (US)

Correspondence Address: SAWYER LAW GROUP LLP, P O BOX 51418, PALO ALTO, CA, 94303, US

(73) Assignee: OnSpec Electronics, Inc., Santa Clara, CA

(21) Appl. No.: 09/683,919

(22) Filed: Mar. 1, 2002

(51) Int. Cl. H04L 9/00

(52) U.S. Cl. 713/201

(57) ABSTRACT

A device for allowing secure identification of an individual when accessing information is disclosed. The device comprises a serial port and a controller coupled to the serial port. The device further includes a storage medium coupled to the controller; the storage medium including security information which can be accessed by the controller. A device in accordance with the present invention may take a variety of physical forms. In a preferred embodiment, a USB (universal serial bus) connection is utilized for connecting the device to a computer. Such a device has a unique ID embedded in an integrated circuit inside the device. The device can optionally store in excess of 1 gigabyte of information. Information within the device can be protected by various layers of security (password layer, unique ID layer, encryption layer). The level of security can include all of these layers, as well as any subset of these layers.

### BACKGROUND OF THE INVENTION

There is a serious need in the United States for home security tracking of movement and activities of foreign nationals. At the present time, foreign nationals have access to easy admittance into the United States. Once they have been admitted into the country, these individuals are very difficult to track. Most technology tracking proposals to date lack installed infrastructure to enable them to be implemented quickly and cost effectively. Because of these problems, actual realized security is often weak, since security is only as strong as the weakest link.

In order to heighten national security, admittance standards must be tightened. But this does not approach the problems discussed above. Once a foreign national is in this country, security will be enhanced if their movements and activities are tracked at key touchpoints, such as airports, car rental businesses, and banks. For such tracking to be effective, hardware infrastructure must be in place. However, as has been mentioned, such hardware infrastructure frequently has not yet been installed. There is also a need for easy and low cost implementation for use of key touchpoints.

Accordingly, what is needed is a system and method for providing a device for secure identification which can make use of presently installed infrastructure and which can be cost effectively used at key touchpoints. The present invention addresses such a need.

### SUMMARY OF THE INVENTION

A device for allowing secure identification of an individual when accessing information is disclosed. The device comprises a serial port and a controller coupled to the serial port. The device further includes a storage medium coupled to the controller; the storage medium including security information which can be accessed by the controller.

A device in accordance with the present invention may take a variety of physical forms. In a preferred embodiment, a USB (universal serial bus) connection is utilized for connecting the device to a computer. Such a device has a unique ID embedded in an integrated circuit inside the device. The device can optionally store in excess of 1 gigabyte of information. Information within the device can be protected by various layers of security (password layer, unique ID layer, encryption layer). The level of security can include all of these layers, as well as any subset of these layers.

### BRIEF DESCRIPTION OF THE DRAWINGS

FIG. 1 is a block diagram of a device for secure identification in accordance with the present invention.

FIG. 2 illustrates a block diagram of the memory that includes security information in accordance with the present invention.

FIGS. 3a, 3b and 3c illustrate embodiments of the device in accordance with the present invention.

FIG. 4 illustrates an example of how a device in accordance with the present invention functions within a system which includes a secure key hub and a plurality of touchpoints.

FIG. 5 illustrates an example of a network of touchpoints utilizing the secure USB device in accordance with the present invention.

FIGS. 6 illustrates an example of data received from interaction of the secure USB device carried by one individual with personal computers in touchpoints, and then stored in the central hub.

### DETAILED DESCRIPTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A device for secure identification of an individual who is accessing information on a computer is disclosed. A device in accordance with the present invention may take a variety of physical forms. In a preferred embodiment, a USB (universal serial bus) connection is utilized for connecting the device to a computer. One of ordinary skill in the art readily recognizes that a number of other serial bus connections could be utilized and their use would be within the spirit and scope of the present invention. For example, the connection could include, but is not limited to, an IEEE Specification 1394 (firewire) port, an infiniband port, a traditional serial port or any other serial port that may be utilized for connection to a PC. Such a device has a unique ID embedded in an integrated circuit inside the device. The device can optionally store in excess of 1 gigabyte of information. Information within the device can be protected by various layers of security (password layer, unique ID layer, encryption layer). The level of security can include all of these layers, as well as any subset of these layers.

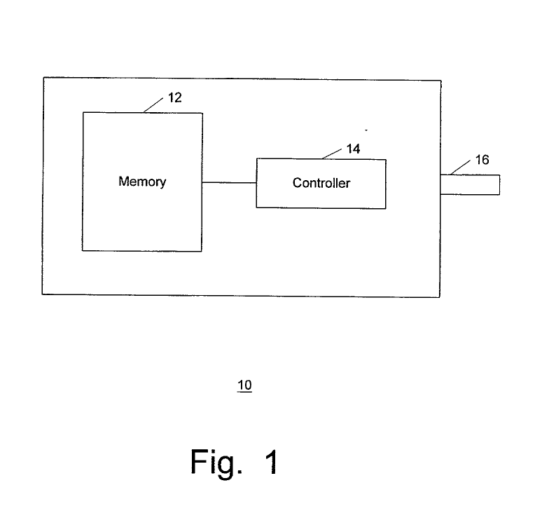

FIG. 1 is a block diagram of a device for secure identification in accordance with the present invention. The device 10 includes a memory 12 and a controller 14 coupled to memory. This device 10 includes a USB port 16 coupled to the controller 14. The memory 12 includes security information which can be accessed by the controller 14. To describe this security information in more detail, refer now to the following discussion in conjunction with the accompanying drawings.

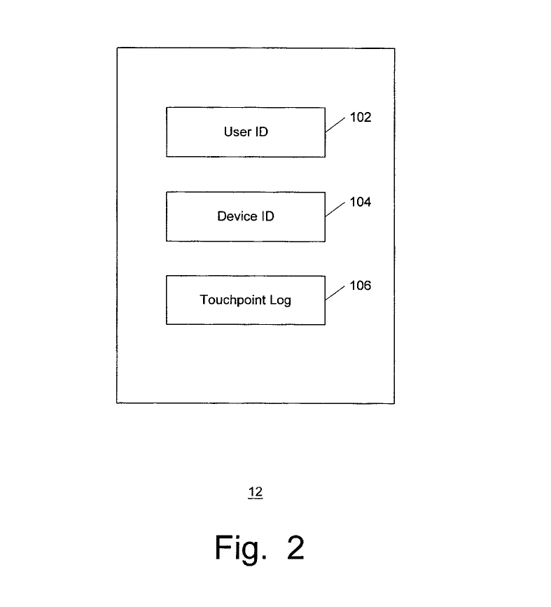

FIG. 2 illustrates a block diagram of the memory 14 which includes security information in accordance with the present invention. The security information in a preferred embodiment includes three levels, 102, 104 and 106. The first level 102 is a specific ID for the individual who uses the device such as a password, biometric information or the like. The second level 104 comprises a unique identifier for the device. Finally, the third layer 106 is a layer which indicates where the device has been used.

In this infrastructure, each location where the security device is used (i.e., a touchpoint) has a unique ID.

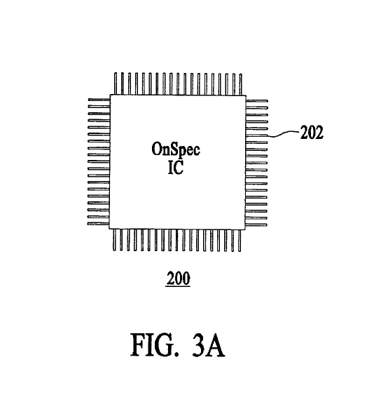

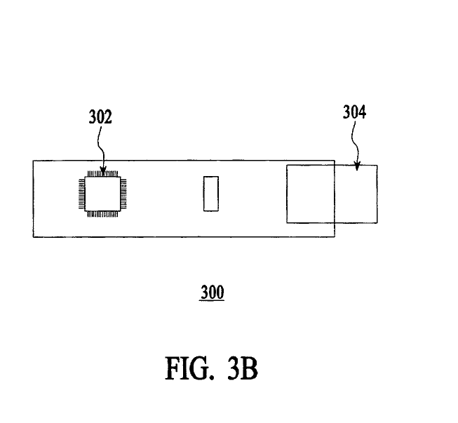

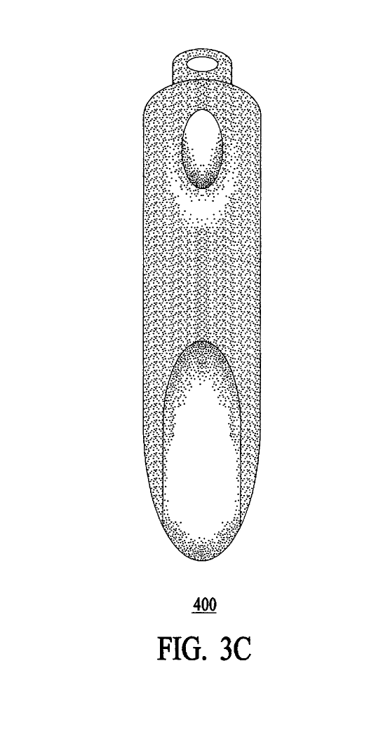

FIGS. 3a, 3b and 3c illustrate embodiments of the device in accordance with the present invention. Embedded in each embodiment of the device is at minimum an integrated circuit (IC) and USB connector. Depending on how much storage is required, an optional Flash memory integrated circuit may also be included in each embodiment.

A first embodiment of the device in accordance with the present invention, as illustrated in FIG. 3a, comprises a secure integrated circuit 200. The integrated circuit includes a USB interface 202. This embodiment comprises a single chip, has seamless compatibility, utilizes low amounts of power, and has a unique ID.

A second embodiment of the device in accordance with the present invention, as illustrated in FIG. 3b, is a printed circuit board (PCB) 300 which can be placed within a personal computer (PC). This embodiment includes an integrated circuit 302, USB connector/interface 304, clock (not shown), and optional external memory (not shown). An advantage of this embodiment is its small, compact size.

A third embodiment of the device in accordance with the present invention, as illustrated in FIG. 3c, comprises a USB secure key printed circuit board (PCB) 400. This embodiment is housed in a plastic enclosure and requires no battery or wires.

The infrastructure utilized to read this device is preferably a PC with a USB port. As before mentioned, the information stored in the device can be stored in multiple layers: a first layer of information is specific to the individual; a second layer of information is the unique ID; and a third layer of information logs each location where the Security Key is used. This data can be read only by authorized personnel. This data can be written to, but there is no overwrite capability (i.e., no tampering with this log). The PC will include an application program which can perform the above-identified functions. In addition, the security scheme within the device can be enhanced or modified by downloading to the device via software or other means.

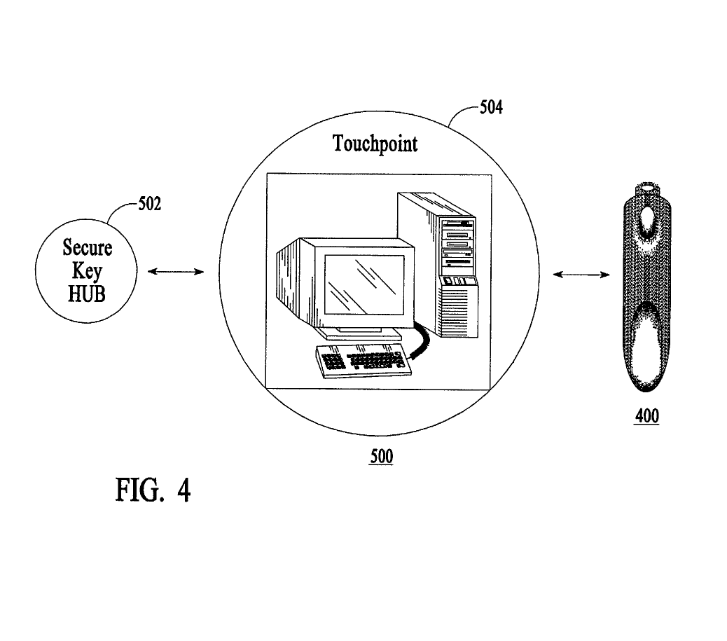

FIG. 4 illustrates an example of how a device in accordance with the present invention functions within a system 500 which includes a secure key hub 502 and a touchpoint 504 and secure key 400 utilized at the touchpoint 504. The secure key hub 502 serves as a centralized data collection point, and is networked with key touchpoints 504. The key touchpoints are located in areas such as airports, car rental agencies, banks, etc. The device in accordance with the present invention interfaces with a personal computer at the key touchpoint. The personal computer at the touchpoint accesses the secure key hub in order to acquire information and then to match that information with information received from the secure key device. Accordingly, the information would be obtained by accessing the individual ID, accessing the device ID, then reading the log of the device and logging the touchpoint information within the device.

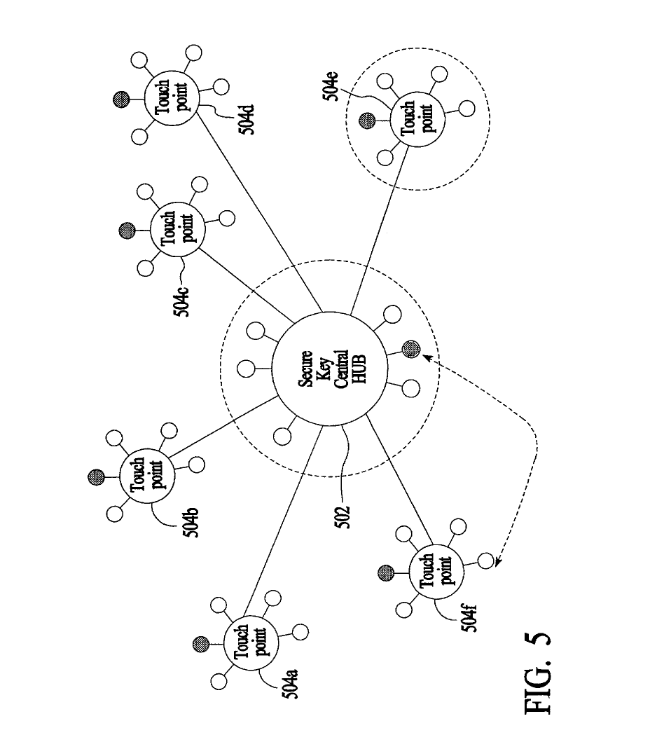

FIG. 5 illustrates an example of a network of touchpoints 504a-504f utilizing the secure USB device in accordance with the present invention. The touchpoints 504a-504f are coupled to a secure key central hub 502. Touchpoints would be at locations such as airports, banks, car rental agencies, etc.

FIGS. 6 illustrates an example of data received from interaction of the secure USB device carried by one individual with personal computers in touchpoints, and then stored in the central hub.

Implementation An example of how the device might function is as follows. Foreign nationals would receive an admittance key. The admittance key would comprise a USB based device in accordance with the present invention which contains key data such as foreign national passport information, picture, etc. The admittance key would also comprise a log portion which would capture each key touchpoint accessed by the foreign national. The USB based device would be capable of accepting data being written into the device's memory, but it would not have overwrite capability. Each USB device would have a unique ID. Encryption would be built into the device. Each unit would cost less than $25.00.

Foreign nationals would pay a rental fee for use of a key. Upon admittance to the United States, the foreign national's data is entered into the admittance key. Foreign nationals would pay a $25 refundable deposit upon admittance to the United States; this would be refunded when they depart the United States if the key is returned. The interest on the deposits would help to pay for the cost of implementing the program.

Another use of a device in accordance with the present invention would be to provide a hardwired identity verification for e-commerce card transactions. The storage mechanism would preferably include additional identifying information.

Advantages Major advantages of the present invention include the following: A major advantage of the present invention is that the key touchpoint infrastructure is 90 percent in place at the present time. USB is a standard component in over 400 million PCs, so that the cost of acquiring and installing proprietary interfaces is eliminated. PCs are already a standard component in banks, airports, car rental agencies, etc. Also, database software for tracking is already available from companies such as Oracle, IBM and Microsoft. Key Touchpoints are already interconnected to the Internet, so that there is no cost for additional hardware or internet connection. A system and method in accordance with the present invention is capable of mass deployment within 60 days, once encryption technology has been agreed upon.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A device for allowing secure identification of an individual when accessing information comprising:
a serial bus port;
a controller coupled to the serial bus port; and
a storage medium coupled to the controller; the storage medium including security information which can be accessed by the controller.

2. The device of claim 1 wherein the serial bus port comprises any combination of a firewire port, USB port or an infiniband port.

3. The device of claim 1 in which the storage medium comprises a memory.

4. The device of claim 1 in which the security information comprises a plurality of levels.

5. The device of claim 4 wherein the plurality of levels comprises any combination of a level for providing the identity of the individual; a level for identifying a unique identifier for the device; and a level for indicating where the device has been used.

6. The device of claim 4 wherein the plurality of levels comprises any combination of a first level for providing the identity of the individual; a second level for identifying a unique identifier for the device; and a third level for indicating where the device has been used.

7. The device of claim 5 wherein the identity of the individual being provided access is via a password.

8. The device of claim 5 wherein the identity of the individual is provided via biometric information.

9. The device of claim 4 wherein the plurality of levels are tamper proof.

10. The device of claim 1 wherein the security information can be enhanced or modified by downloading data to the device.

11. A system for allowing for secure identification of an individual when accessing information comprising:
a central hub;
a plurality of key touchpoints coupled to the central hub; and
at least one device coupled to at least one of a plurality of key touchpoints, the at least one device comprising a serial port ; a controller coupled to the serial port; and a storage medium coupled to the controller; the storage medium including security information which can be accessed by the controller.

12. The system of claim 11 wherein the serial bus port comprises any combination of a firewire port, USB port or an infiniband port.

13. The system of claim 11 wherein each of the last one touchpoints comprises a personal computer.

14. The system of claim 11 in which the storage medium comprises a memory.

15. The system of claim 11 in which the security information comprises a plurality of levels.

16. The system of claim 15 wherein the plurality of levels comprises any combination of a level for providing the identity of the individual; a level for identifying a unique identifier for the device; and a level for indicating where the device has been used.

17. The system of claim 15 wherein the plurality of levels comprises a first level for providing the identity of the individual; a second level for identifying a unique identifier for the device; and a third level for indicating where the device has been used.

18. The system of claim 16 wherein the identity of the individual is provided access via a password.

19. The system of claim 16 wherein the identity of the individual is provided via biometric information.

20. The system of claim 15 wherein the plurality of levels are tamper proof.

21. The system of claim 11 wherein the security information within a device can be enhanced or modified by downloading data to the device.
